(19) United States
(12) Patent Application Publication
(10) Pub. No.: US 2025/0262598 A1
(43) Pub. Date: Aug. 21, 2025

(54) Membranes with precision Nanopores and Method for Manufacture Thereof

(71) Applicant: Jan Vetrovec, Larkspur, CO (US)

(72) Inventor: Jan Vetrovec, Larkspur, CO (US)

(21) Appl. No.: 18/831,484

(22) Filed: Feb. 20, 2025

Related U.S. Application Data
(60) Provisional application No. 63/630,642, filed on Feb. 20, 2024.
(60) Provisional application No. 63/630,877, filed on Mar. 7, 2024.

(51) Int. Cl. B01D 69/02; B01D 53/22; B01D 67/00

(52) U.S. Cl. CPC B01D 69/02; B01D 53/228; B01D 67/0025; B01D 67/0055; B01D 2325/0212; B01D 2325/02831; B01D 2325/02832; B01D 2325/02833; B01D 2325/02834; B01D 2325/04

(57) ABSTRACT

This invention is for membranes with precision nanopores (also known as precision nanopore membranes or PNM) offering exceptional permeability and selectivity for separation of gas mixtures. Other applications include microfiltration. The subject PNM has high precision nanopores directly connecting the opposite sides of the membrane, thus avoiding a torturous path fort gas transport of prior art nanoporous membranes. Pores are oriented generally perpendicular to the membrane surface and may occupy a large fraction of membrane surface area. This beneficially offers reduction in membrane thickness and reduced operating pressures. This arrangement offers allow extreme reduction in membrane thickness ensuring high permeability and low driving pressures. The PNM allow for a simplified construction of the separator and a process with much reduced energy consumption compared to current commercial practice.

### CROSS-REFERENCE TO RELATED APPLICATIONS:

This patent application claims priority from U.S. provisional patent applications U.S. Ser. No. 63/630,642, filed on Feb. 20, 2024 and entitled “Membranes with Precision Nanopores and Method for Manufacture Thereof” and U.S. Ser. No. 63/630,877, filed on Mar. 7, 2024 and entitled “Membranes with Precision Nanopores and Method for Manufacture Thereof”, the entire contents of all of which are hereby expressly incorporated by reference.

### FIELD OF THE INVENTION

The present invention relates to gas separation membranes and more particularly to nanoporous separation membranes or the like.

### BACKGROUND OF THE INVENTION

Numerous industrial and commercial processes require inflow of specific gas that is not readily available in nature at sufficient concentration or not available in a sufficiently pure form. To meets this need, a given mixture gases may be processed to separate and possibly purify one or more constituent gases. Examples may include: 1) The separation of nitrogen, oxygen, and noble gases from air, 2) Separation of hydrogen from gases like nitrogen and methane, 3) Separation of helium from natural gas, 4) Enrichment of air by oxygen for medical or combustion purposes, and 5) Recovery of hydrogen from product streams in ammonia plants and processes in oil refineries.

One attractive approach to gas separation uses membranes, which act as permeable barrier through which different gases move across at different rates or do not move at all. Gas separation across a membrane is a pressure-driven process, where the driving force is the difference in pressure between inlet of raw material and outlet of the product. The performance of the membrane depends on permeability and selectivity. Permeability is affected by the gas molecule size; larger molecules have a lower diffusion coefficient. Gas separation membranes (GSM) with high selectivity offer the potential to provide game-changing gas separation process with significant energy savings.

The membrane gas separation equipment typically pumps gas into the membrane module and the targeted gases are separated based on difference in diffusivity. For example, oxygen (larger molecules) may be separated from ambient air and collected at the upstream side of the membrane while nitrogen (having smaller molecules) may be separated from ambient air and collected at the downstream side of the membrane.

One class of GSM are polymer membranes that have reached a certain level of maturity in a variety of industries. Polymer membranes are examples of systems that are dominated by the solution-diffusion mechanism. The polymer membrane may be considered to have holes in which the gas can dissolve (solubility) and the molecules can move from one hole to another (diffusion). However, polymers with a high selectivity have a low permeability and opposite is true; materials with a low selectivity have a high permeability. This is known as the Robeson limit. (See, e.g., Robeson, L.M. (1991), “Correlation of separation factor versus permeability for polymeric membranes”, Journal of Membrane Science. 62 (165): 165-185.) Thus, high selectivity polymer membranes require high driving pressure, which translates to large expenditure of energy. Polymer membranes also have a limited lifetime.

Another class of GSM known as nanoporous membranes are fundamentally different from the polymer-based membranes. Nanoporous GSM may be considered to be structures comprising tiny passages (nanopores) and, in some cases, tiny chambers interconnected by nanopores. Such porous structures may be naturally produced by a variety of crystalline materials such as silica, zeolites, petrovskites, and alike. These materials may be adapted for construction of GSM. High porosity of some of these nanoporous GSM supports high permeability. Nanoporous GSM are not subject to the Roberson limit. However, such nanopores have randomly changing directions and they may not always connect the two membrane surfaces. Gas molecules going through the torturous passage formed by such random structures requires significant driving pressure to attain reasonable permeation through the membrane.

The technical challenges of prior art nanoporous GSM may be overcome with advanced membranes in accordance with the subject invention having precision nanopores that are substantially straight and smooth while providing more direct pathway for molecular transport across the membrane.

### SUMMARY OF THE INVENTION

This invention is for membranes with precision nanopores (also known as precision nanopore membranes or PNM) offering exceptional permeability and selectivity for separation of gas mixtures. The subject PNM has high-precision nanopores directly connecting the opposite sides of the membrane, thus avoiding a torturous path for gas transport in prior art nanoporous membranes. Pores are oriented generally perpendicular to the membrane surface and may occupy a large fraction of membrane surface area. This beneficially offers reduction in membrane thickness and reduced operating pressures. This arrangement offers allow extreme reduction in membrane thickness ensuring high permeability and low driving pressures. The PNM allow for a simplified construction of the separator and a process with much reduced energy consumption compared to current commercial practice.

In one embodiment, the PNM of the subject invention comprises a plurality of nanoporous members individually installed in a support plate. Each nanoporous member may be formed as elongated object (including a fiber) with two ends. Each nanoporous member has a plurality of longitudinal nanopores (holes) fluidly connecting the two ends of the nanoporous member. Such a structure may be also referred to as a “holey fiber.” The nanopores are arranged so that gas molecules may be transported via the longitudinal nanopores through the nanoporous member from one end to another. Each such nanoporous members may be about 100 to 5000 micrometers in length. The nanopores may have a generally circular cross-section with an approximate diameter in the range of about 0.5 to 1000 nanometers. The exact size of the nanopores is determined by the manufacturing process. The nanoporous members may be made of silica, glass, polymer, or either suitable material and they may be precision cut or cleaved from a much longer holey fiber. The nanoporous members may be installed into a support plate so that the nanopores provide a fluid connection between the two support plate faces. In particular, each nanoporous member has one end fluidly connected to one face of the plate and the other end fluidly connected to the other face of the plate. The gaps between and the plate are sealed with a sealant having low permeability to the working gas in a gas separation process. The sealant also holds the nanoporous members in place. In this embodiment, the nanoporous members may have a circular external shape or other suitable external shape.

In another embodiment, the PNM of the subject invention comprises a plurality of nanoporous members, which are stacked side-by-side with a sealant and/or adhesive therebetween to form a plate-like object with transverse direction 10-1000 times its thickness. In this embodiment, the nanoporous members may also have a hexagonal external shape.

In yet another embodiment, the PNM of the subject invention comprises a plurality of nanoporous members, which are stacked side-by-side and fused together by application of heat so that there are no significant gaps therebetween. In this embodiment, the nanoporous members preferably have a hexagonal external shape.

In still another embodiment, the PNM of the subject invention comprises a generally flat and thin member (plate) comprising a base material and nanopores. The plate may be about 1 to 100 micrometers thick with transverse dimensions about 1 to several hundreds of millimeters. The plate has a plurality of nanopores (holes) fluidly connecting one side of the plate to the opposite side so that gas molecules may be transported through the holes from one side of the plate to the opposite side. The nanopores may have a circular cross-section with an approximate diameter of about 0.5 to 1000 nanometers. The base material may be silica, glass, or polymer, or other suitable material.

The PNM of the subject invention may be produced by one of more steps comprising stacking, fusing, rolling, drawing, extrusion, and slicing.

Accordingly, it is one object of the present invention to provide nanoporous membranes for gas separation process having precisely defined nanopore sizes.

It is another object of the present invention to provide nanoporous membranes for gas separation process having high selectivity of gaseous species.

It is yet another object of the present invention to provide nanoporous membranes for gas separation process having with substantially straight nanopores that fluidly connect the two sides of the membrane.

It is still another object of the present invention to provide nanoporous membranes for gas separation process having high permeability.

It is further object of the present invention to provide nanoporous membranes for gas separation process that are producible from low cost material.

It is yet further object of the present invention to provide nanoporous membranes for separation nitrogen, oxygen, and noble gases from air.

It is still further object of the present invention to provide nanoporous membranes for separation of hydrogen from gases like nitrogen and methane.

It is an additional object of the present invention to provide nanoporous membranes for separation of helium from natural gas.

It is yet additional object of the present invention to provide nanoporous membranes for enrichment of air by oxygen for medical or combustion purposes.

It is still additional object of the present invention to provide nanoporous membranes for the recovery of hydrogen from product streams in ammonia plants and processes in oil refineries.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

FIG. 1A is a view of the precision nanopore membrane (PNM) according to one embodiment of the subject invention.

FIG. 1B is a cross-sectional view 1B-1B of the PNM of FIG. 1A.

FIG. 2 is an enlarged portion 2 of the PNM of FIG. 1B.

FIG. 3 is a cross-sectional view of nanoporous member of FIG. 2.

FIG. 4 is view 4-4 of FIG. 3.

FIG. 5 is a cross-sectional view of the membrane module.

FIG. 6A is a view of the PNM according to another embodiment of the subject invention.

FIG. 6B is a cross-sectional view 6B-6B of the PNM of FIG. 6A.

FIG. 7 is an enlarged portion 7 of the PNM of FIG. 6A.

FIG. 8 is an alternative construction of the of items shown in FIG. 7.

FIG. 9 is an isometric view of elongated holey fibers forming a bundle.

FIG. 10 is a is an isometric view of the bundle of FIG. 9 being fused into a solid unit.

FIG. 11 is a is an isometric view of the bundle of FIG. 10 sliced into nanoporous plates.

FIG. 12 is an isometric view of a variant of the nanoporous plate of FIG. 11 offering improved permeability to selected gas specie.

FIG. 13 is an enlarged cross-sectional view of portion 13 of FIG. 12.

FIG. 14 is an isometric view of a stack of tubes for fabricating a first preform.

FIG. 15 is an isometric view of a first preform made by fusing the tubes.

FIG. 16 is a schematic diagram showing fabrication of a first preform by extrusion of a bulk billet.

FIG. 17 is a photograph of an exemplary extruded preform.

FIG. 18 is a schematic diagram showing the drawing of a first fiber from the first preform.

FIG. 19 is an isometric view of the first fiber being diced into first fiber segments.

FIG. 20 is an isometric view of a stack of first fiber segments for fabricating a second preform.

FIG. 21 is an isometric view of a second preform made by fusing the first fiber segments.

FIG. 22 is a schematic diagram showing the drawing of a second fiber from the second preform.

FIG. 23 is an isometric view of the second fiber being diced into second fiber segments.

FIG. 24 is an isometric view of a stack of second fiber segments for fabricating a third/last preform.

FIG. 25 is an isometric view of a third/last preform made by fusing the second fiber segments.

FIG. 26 is an isometric view of a third/last preform diced into PNM.

FIG. 27 is a photograph of a cross-section of a commercial rod with 6 microcapillaries.

FIG. 28A is a diagram showing the condition of the microporous assembly at the beginning of the downsizing process.

FIG. 28A is a diagram showing the condition of the microporous assembly at the ending of the downsizing process.

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

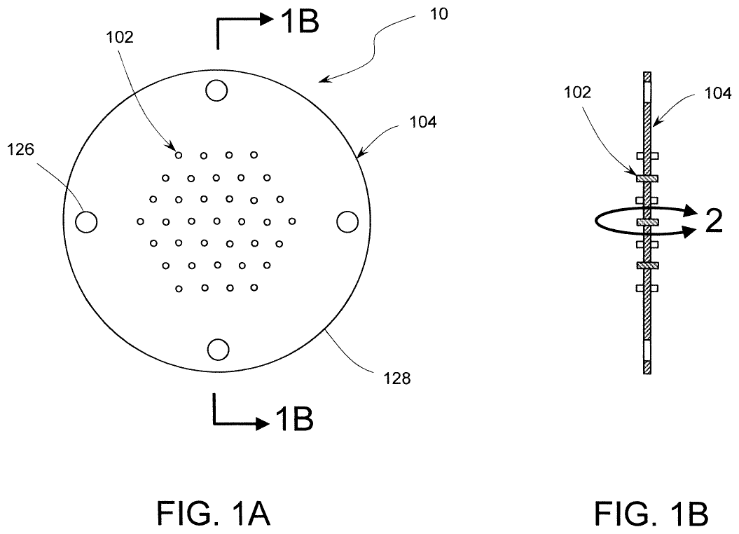

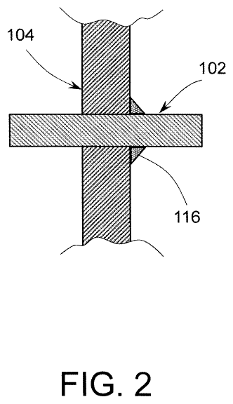

Referring now to the drawings, a precision nanopore membrane (PNM) according to one embodiment of the present invention is shown in FIGS. 1A, 1B, and 2 and generally designated at 10. The PNM 10 comprises a plurality of nanoporous members 102 and a mounting plate 104.

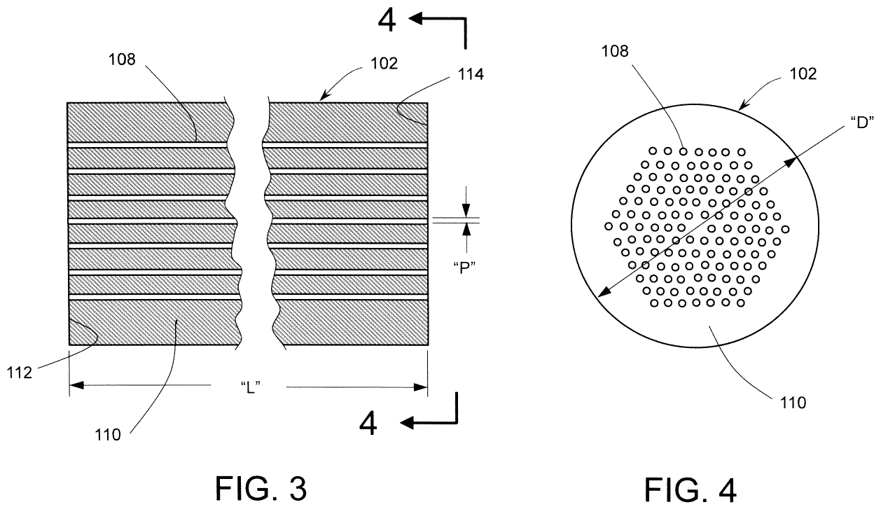

Referring now to FIGS. 3 and 4, each nanoporous member 102 comprises a solid body 110 and a plurality of longitudinal nanopores (holes) 108 with the body. The solid body 110 may be formed as a parallelepiped with a perimeteral surface 122, a first end surface 112, and a second end surface 114. The perimeteral surface 122 is preferably cylinder with a circular base but it could other shapes without impeding the function of the invention. For example, the perimeteral surface 122 may be a cylinder with an elliptical base, or oval base, or hexagonal base, and alike. The solid body 110 may have a diameter “D” ranging from about 10 micrometers to about 1,000 micrometers (1 millimeters) and a length “L” ranging from about 100 to 5,000 micrometers (5 mm). The solid body 110 of the nanoporous member 102 may be made of fused silica, glass, polymer, or other suitable material.

The nanopores 108 are installed in the solid body 110 and generally parallel to each other. Each nanopore 108 is arranged to fluidly connect the first end surface 112 the solid body 110 to the second end surface 114. The nanopores 108 may have a generally circular cross-section with a diameter “P” selected to be the range of about 0.2 to 1000 nanometers. The exact size of the nanopores 108 is selected according to the application and established by the manufacturing process. The manufacturing process is known to slightly distort the shape of the nanopore from circular to elliptical, oval, and alike. Such slight distortions may not significantly impede the functionality of the invention. The nanopores 108 allow for certain gas molecules to be transported (flow) through the nanoporous member 102. In particular, gas specie with molecules substantially smaller than the nanopore diameter “P” may be transported through the nanoporous member 102. Conversely, gas specie with molecules substantially larger than the diameter “P” of the nanopore 108 may be not transported through the fiber segment 102. Therefore, the nanoporous member 102 may function as a molecular sieve and be used for gas separation.

In practice, nanoporous members 102 may be precision cut or cleaved from a much longer holey fiber. Holey fibers (also known as photonic crystal fibers) are currently manufactured for a range of photonic applications. Current production techniques allow for nanopore (hole) size down to about 500 nanometers. This disclosure will reveal a method for producing holey fibers with nanopore (hole) size down to about 0.2 nanometers for use in gas separation.

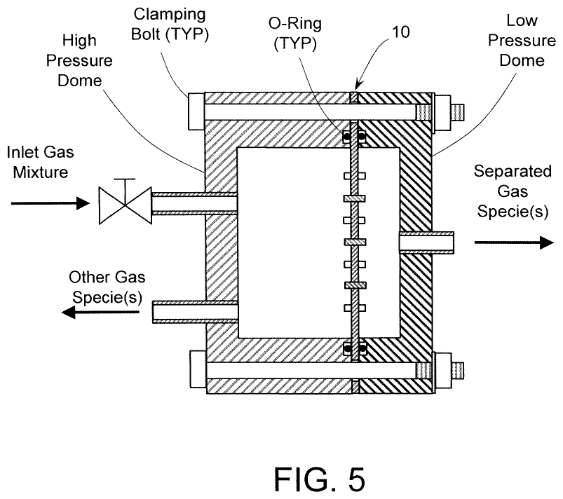

A practical PNM 10 for gas separation should have a very large quality of nanopores 108, typically thousands to millions. Therefore, a plurality (tens, hundreds, thousands, or alike) of nanoporous members may be installed into a mounting plate 104. The mounting plate 104 provides a mechanical support for the nanoporous members 102 when the PNM 10 is installed in a gas separation module such as shown in FIG. 5. The mounting plate 104 is preferably made of made of suitable high-strength material such as metal or ceramic. Thickness of the mounting plate 104 is preferably selected to be in the range of about 0.025 to several millimeters. The perimeter 128 of the mounting plate (shown as circular) is arbitrary and depends on how the mounting plate is installed in the membrane module. The perimeter 128 of the mounting plate is preferably selected to be in the range of about 10 to 300 millimeters. Clearance holes 126 may be provided in the mounting plate 104 for installation into the membrane module. The nanoporous members 102 are installed so as to provide a fluid connection between the two faces of the mounting plate 104. Each nanoporous member 102 is preferably arranged to partially protrude through the mounting plate 104 and affixed in position by a sealant 106. In particular, each nanoporous member 102 has one end fluidly connected to one face of the plate and the other end fluidly connected to the other face of the plate. The gaps between the nanoporous members 102 and the plate are sealed with a sealant 116 having low permeability to the working gas in a gas separation process. The sealant 116 also holds the fiber segments in place. Suitable sealant 116 is preferably a curable compound such as epoxy, room-temperature-vulcanizing (RTV) silicon rubber, ultraviolet (UV)-curable adhesive, and alike.

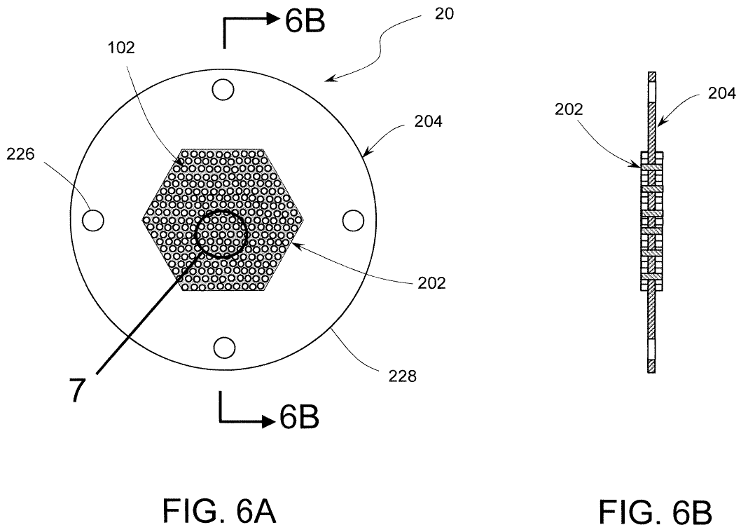

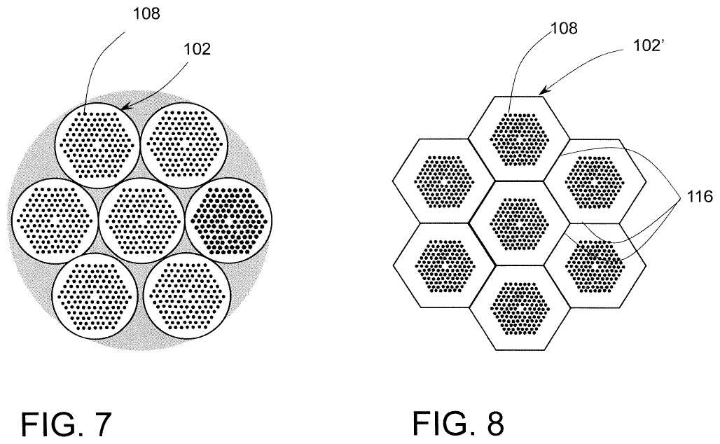

Referring now to FIGS. 6A and 6B, there is shown a PNM 20 according to another embodiment of the present invention. The PNM 20 comprises a stack of nanoporous members 202 and a mounting plate 204. The stack 202 comprises a plurality of nanoporous members 102 (such as shown in FIGS. 3 and 4), which are stacked side-by-side as shown in FIG. 7. A sealant and/or adhesive is installed between the individual nanoporous members 102 so that the stack of nanoporous members 202 is formed into a solid object, which can be installed onto the mounting plate 204. Preferably, the nanoporous members may have hexagonal perimetral surfaces as the nanoporous members 102′ in FIG. 8. The hexagonal surfaces allow for easier stacking and bonding.

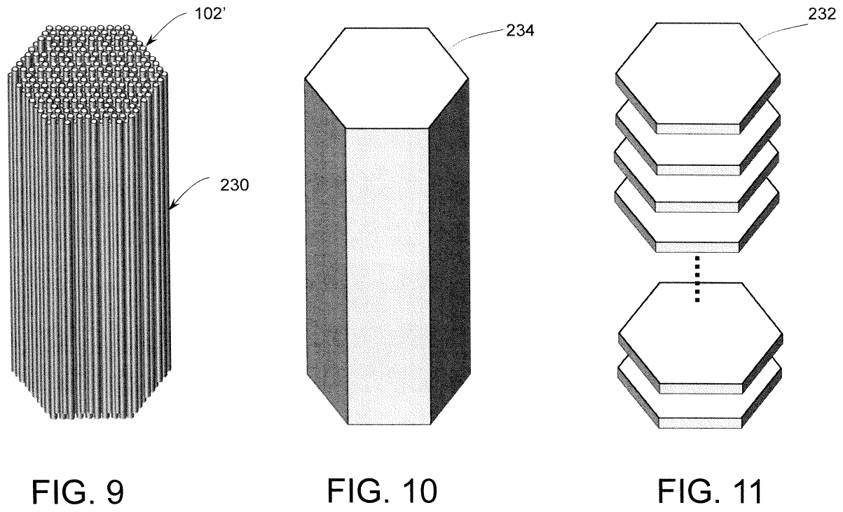

To allow for even easier fabrication, the nanoporous members 102′ (hexagonal perimetral surfaces) may be provided as long units (about 50 to about 300 millimeters long) and stacked side-by-side into a bundle 230 as indicated in FIG. 9. The nanoporous members 102′ are then fused together into a nanoporous billet 234 by application of heat so that there are no significant gaps therebetween. The nanoporous billet 234 (FIG. 10) may be then sliced into a plurality of relatively thin nanoporous plates 232 as shown in FIG. 11. Resulting nanoporous plates 232 may be installed onto their corresponding mounting plates 204 to form a plurality of PNM.

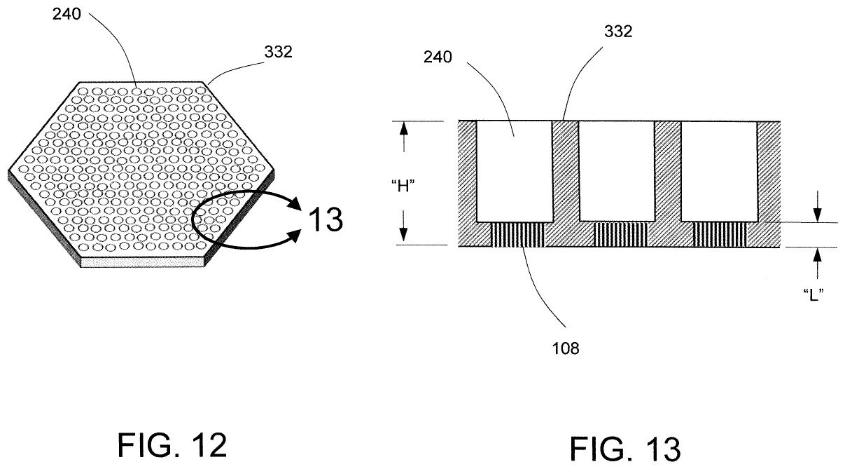

Referring now to FIG. 12, there is shown a nanoporous plate 332 for a construction of a PNM offering much improved permeability to gas molecules. The nanoporous plate 332 has a thickness “H” (typically in the millimeter range), which is established to provide the plate with sufficient rigidity to handle the load due to gas pressure. To shorten the length of the nanopores 108, pockets 240 are machined into the material of nanoporous plate 332. Suitable process for machining the pockets may include laser ablation by an ultrafast laser. Depth of the pockets is established so that the length “L” of nanopores 108 is reduced to as little as several micrometers resulting in a membrane-like structure. As a result, impedance of the nanopores 108 to gas flow is significantly reduced and the permeability of the PNM to the selected gas specie is increased.

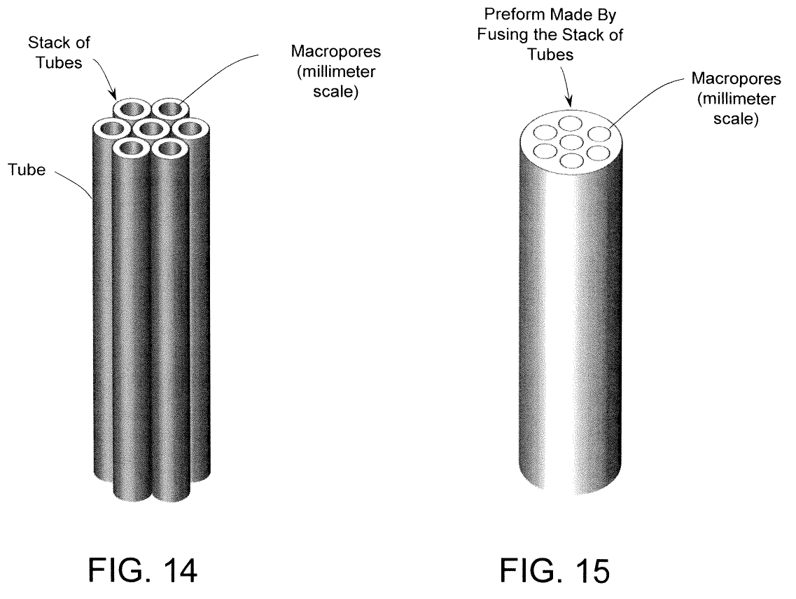

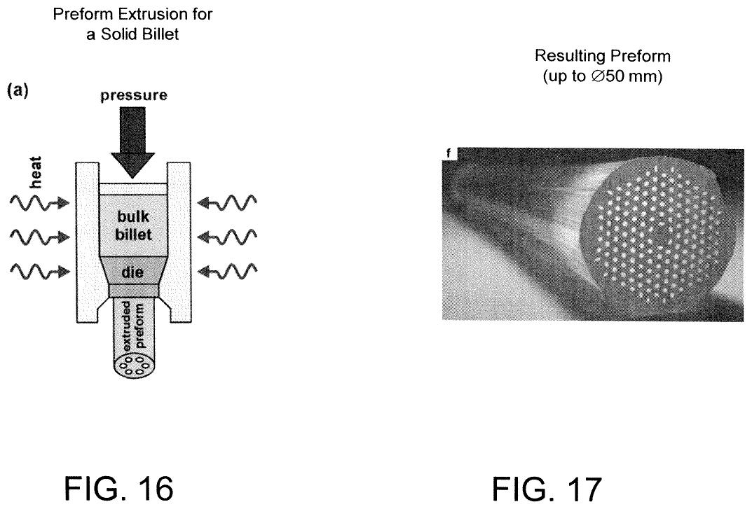

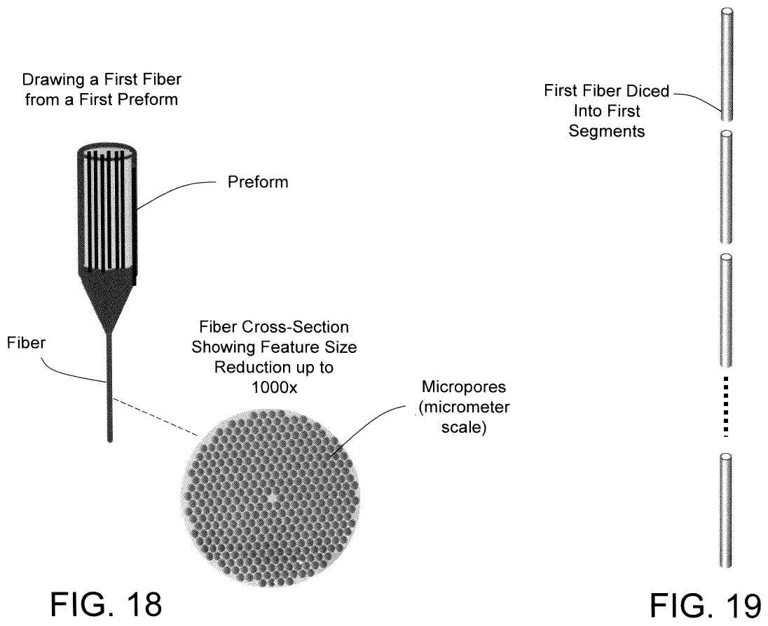

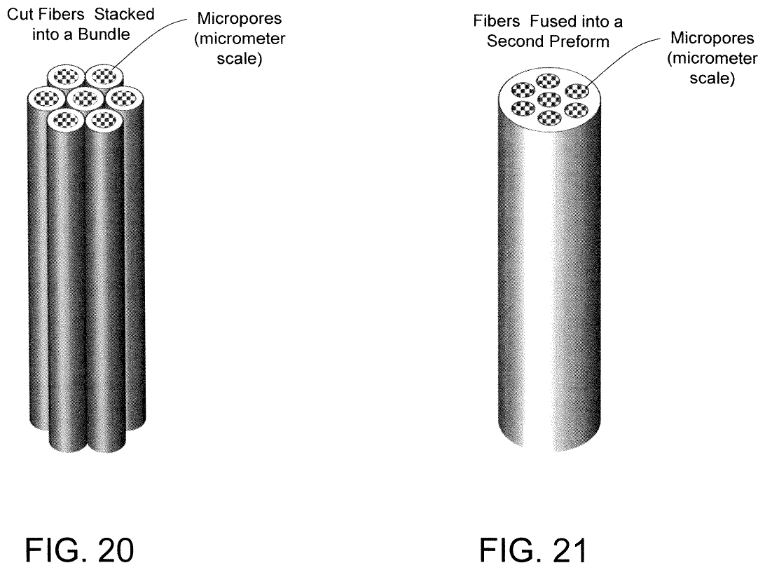

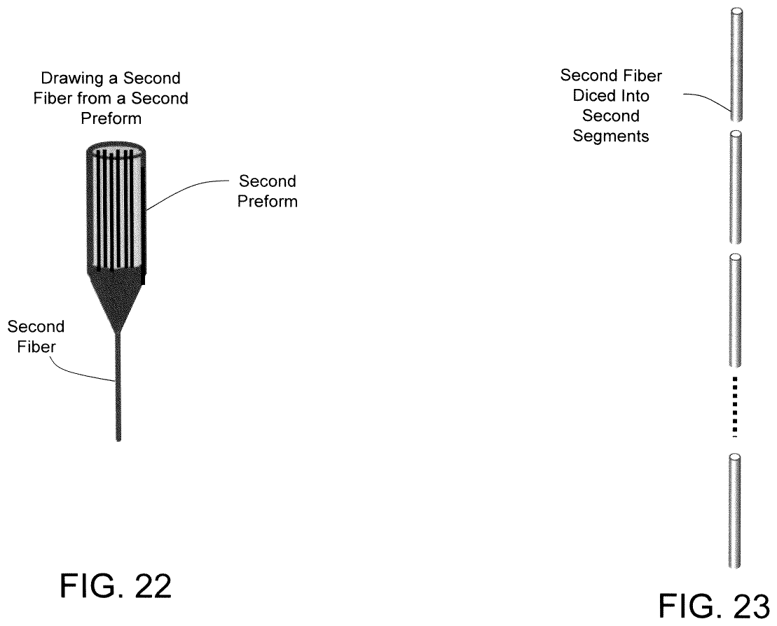

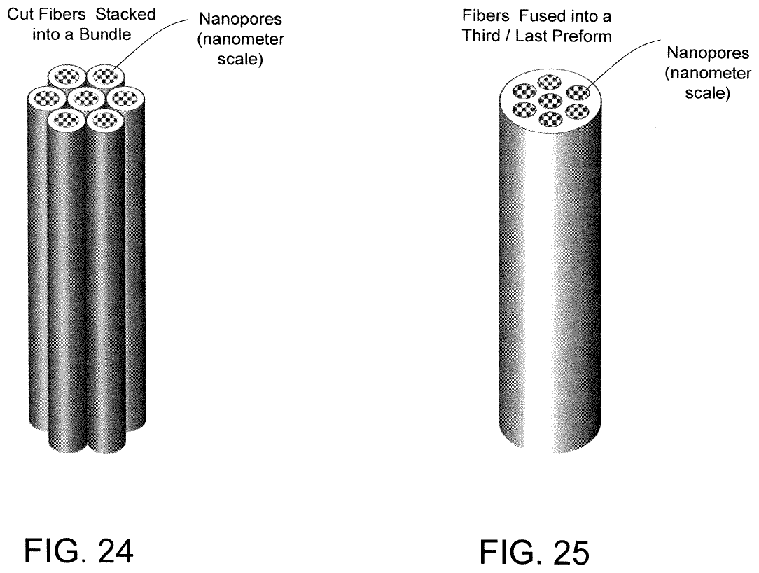

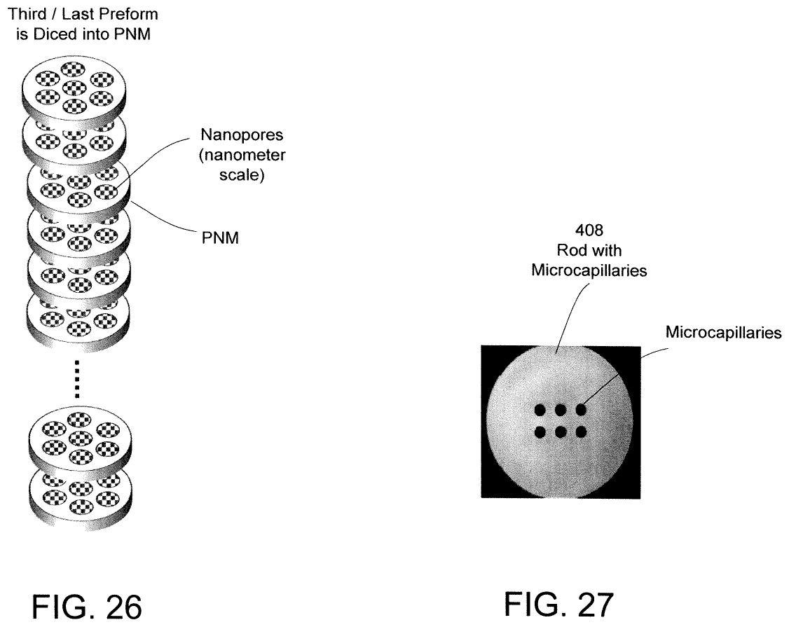

Fabrication of nanoporous structures for the construction of PNM analogous to the technological steps used for fabrication of microstructured optical fibers for photonic applications. This approach is known to work for glass and polymer work materials, which are also suitable materials for the construction of PNM for gas separation applications. Initially, a first “preform” is fabricated. One path is to provide the work material in tubes, which are then stacked into a bundle shown in FIG. 14 and heated to allow for the individual tubes to become fused into the first preform as shown in FIG. 15. Another way to fabricate the first preform is by extrusion starting from a bulk billet of the work material as shown in FIG. 16. This approach is described in detail in and technical paper by H. Ebendorff-Heidepriem and T. M. Monro entitled “Extrusion of complex preforms for microstructured optical fibers,” published in OPTICS EXPRESS, 12 Nov. 2007/Vol. 15, No. 23, the entire contents of which are incorporated herein by reference. Using either approach, preforms of up to 50 mm in diameter may be fabricated with hole (feature) sizes down to about a millimeter, FIG. 17. As the next step, the first preform is heated and used to draw a first fiber. In this rather conventional process, the feature size undergoes a reduction by up to a factor of about 100 to 1000, FIG. 18. For example, if the first preform had holes 1 mm in diameter, these will now become 1-10 micrometers in size. The resulting first fiber is then cut into segments of suitable length (hundreds of millimeters) as shown in FIG. 19 and the cut fiber segments are stacked into a bundle shown in FIG. 20. The bundle is then heated to allow for the individual fiber segments to become fused into one (porous) solid as show in FIG. 21, which will serve as a second preform. As the next step, the second preform is heated and used to draw a second fiber as shown in FIG. 22. The feature size undergoes another reduction by up to a factor of about 100 to 1000. For example, if the first preform had holes 1 mm in diameter, these will now become nanopores with 1-100 nanometers in size. The resulting second fiber is then cut into segments of suitable length (hundreds of millimeters) as shown in FIG. 23 and the cut second fiber segments are stacked into a bundle shown in FIG. 24. The bundle is then heated to allow for the individual fiber segments to become fused into one (porous) solid as show in FIG. 25. The process may be repeated until the desired nanopore size is attained in a last preform. The preform is then sliced with a diamond saw or alike to produce nanoporous plates for the PNM, FIG. 26. The nanoporous plates may be further machined to reduce the nanopore length to as little as few micrometers.

One key challenge is producing nanometer size pores by downsizing the size pores in commercially available holey fibers. The above-described methods employ optical fiber pulling technologies are available from relatively few vendors. An alternative method to the above-described approaches that may be easier to practice involves rolling. In the rolling method, one may start with a rod 408 having one or more microcapillaries such as shown in FIG. 27. Suitable rod 408 is preferably made of glass (e.g., borosilicate or soft glass) or silica. The rod 408 may have an outside diameter ranging from about one to several millimeters. The microcapillaries may have a diameter ranging from around 50 to 150 micrometers and are suitable to receive a holey fiber (such as shown, e.g., in FIGS. 18 and 19). Suitable rods with microcapillaries are available commercially, for example, from Nippon Electric Glass (NEG) Co. LTD. in Japan.

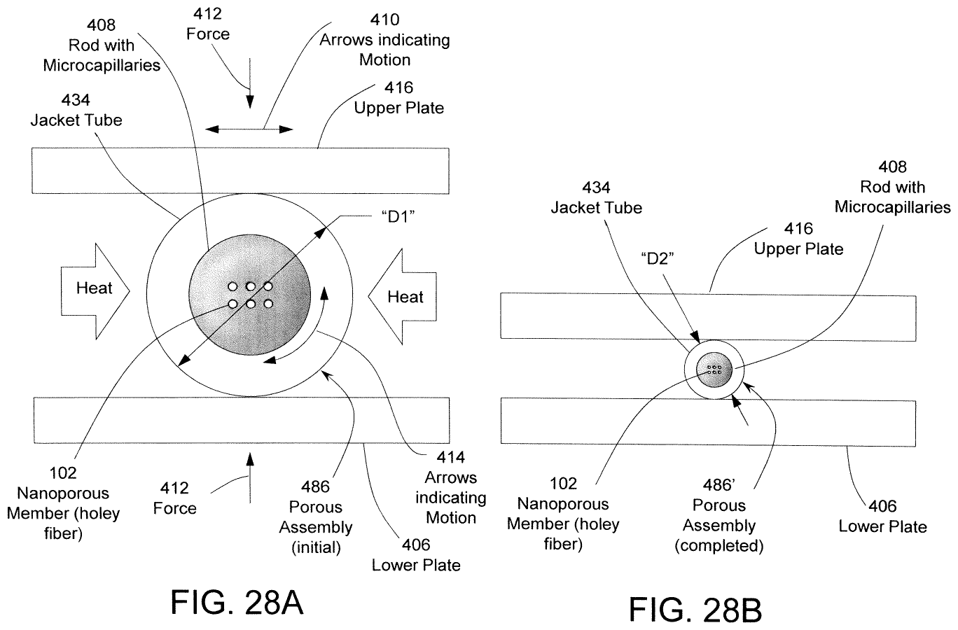

Referring now to FIGS. 28A and 28B, there is illustrated a method for downsizing the pore size in a nanoporous member 102. First, a porous composite assembly 486 is formed comprising the rod 408, jacket tube 434, and suitable nanoporous members 102 (holey fibers) are cut to about the same length “LL”. Then, the jacket tube 434 (preferably tightly fitting) is installed over the rod 408 and the holey fibers (nanoporous members) 102 are installed into the capillaries of the rod 408; preferably one fiber per capillary. The resulting porous composite assembly 486 is placed between suitably rigid lower plate 406 and upper plate 416. The plates 406 and 416 are preferably made of material having low thermal conductivity. For example, the plates 406 and 416 may be made of ceramic material. Heat is applied to the porous composite assembly 486 by means of gas torch, radiative heat, hot gas, or other suitable means. Meanwhile, the upper plate 416 is moved back and forth as indicated by arrows 410 so that the porous composite assembly 486 rolls back and forth (as indicated by arrows 414) on the lower plate 406 as it is being heated. Substantially concurrently, vertical force 412 is applied. The porous composite assembly 486 is heated to the point when the glass of the jacket tube 434, the rod 408, and the holey fiber 102 are sufficiently ductile so that the above-described motion results in gradual decrease of the diameter “D1” (FIG. 28A) without application of excessive force 412. Preferably, the softening temperature of the jacket tube 434 is somewhat higher than that of the rod 408. The coefficient of thermal expansion (CTE) of the material of the jacket tube 434 should be matched to that of the rod 408. Once the diameter of the porous composite assembly 486′ reaches a predetermined size “D2” (FIG. 28B), heat may be removed and the process may be stopped. At that point the size of the pores in holey fibers 102 has been reduced by a factor of D1/D2 from their original size. By then, the original length “L1” of the assembly 486 has increased by a about a square of D2/D1. The process may be repeated to attain further pore size reduction. For example, a new “jacket tube” with one or more holes may receive the resulting assembly 486 of FIG. 28B and be downsized in already described manner. A variant of this process may use two rollers at fixed positions to replace the lower plate 406.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

The term “suitable”, as used herein, means having characteristics that are sufficient to produce a desired result. Suitability for the intended purpose can be determined by one of ordinary skill in the art using only routine experimentation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof. Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A precision nanopore membrane (PNM) comprising a nanoporous member formed by extrusion;
a. Said nanoporous member having a solid body and a plurality of nanopores within said body;
b. Said solid body having a lateral dimension “D” and longitudinal dimension “L”;
c. Said body having a first surface and a second surface; said surfaces being separated by a distance “L”;
d. Said nanopores being generally straight and arranged to fluidly connect said first surface and said second surface;
e. Said nanopores being substantially parallel to each other;
f. Said nanopores being substantially perpendicular to said first surface and said second surface; and
g. Said nanopores having generally circular cross-section.

2. The PNM of claim 1, wherein said body is formed as a parallepiped.

3. The PNM of claim 1, wherein said body is formed from a material selected from the family consisting of fused silica, glass, soft glass, polymer, and polymethylmethacrylate (PMMA) polymer.

4. The PNM of claim 1, wherein said nanopores have a lateral dimension in the range of 0.1 and 1000 nanometers.

5. The PNM of claim 1, wherein said longitudinal dimension “L” is selected to be in the range of 100 to 5000 micrometers.

6. The PNM of claim 1, wherein said lateral dimension “D” is selected to be in the range of 10 to 1000 micrometers.

7. The PNM of claim 1, additionally comprising a plurality of nanoporous member formed by extrusion, wherein said nanoporous members are attached to each other side-by-side to form a bundle.

8. The PNM of claim 7, wherein said attachment is made a method selected from the family consisting of adhesive bonding and fusion bonding.

9. The PNM of claim 7, wherein said attachment is made a method that forms a hermetic seal.

10. The PNM of claim 1, wherein said nanoporous member has a round perimetral surface.

11. The PNM of claim 1, wherein said nanoporous member has a hexagonal perimetral surface.

12. A process for fabrication a precision nanopore membrane (PNM) including the steps of:
a. Manufacturing a first preform;
b. Drawing said first preform into a first fiber;
c. Dicing said first fiber into first fiber segments;
d. Stacking said first fiber segments;
e. Fusing said stacked first fiber segments into a second preform;
f. Drawing said second preform into a second fiber;
g. Dicing said second fiber into second fiber segments;
h. Stacking said second fiber segments;
i. Fusing said stacked second fiber segments into a last preform; and
j. Slicing said last preform into nanoporous plates.

13. The process of claim 1 further including the step of machining pockets into said nanoporous plates.

14. The process of claim 1 wherein said first preform is produced by extruding.

15. The process of claim 1 wherein the step of fusing said stacked second fiber segments into a last preform is replaced by the steps of 1) Fusing said stacked second fiber segments into a third preform, 2) Drawing said third preform into a third fiber, 3) Dicing said third fiber into third fiber segments, 4) Stacking said third fiber segments; and 5) Fusing said stacked third fiber segments into a last preform.

16. The process of claim 1 wherein the material of the first preform is selected from the group consisting of fused silica, glass, soft glass, polymer, and polymethylmethacrylate (PMMA) polymer.

17. A PNM formed by the process of claim 12.

18. A PNM formed by the process of claim 13.

19. A PNM formed by the process of claim 15.

16. A PNM formed by the process of claim 16.
